(19) United States
(12) Patent Application Publication
(10) Pub. No.: US 2013/0057199 A1
(43) Pub. Date: Mar. 7, 2013

(54) ELECTRICAL JUNCTION BOX MOUNTED ELECTRONIC DEVICE CHARGING STATION

(71) Applicant: Albert G. Langella, Hartsdale, NY (US)

(72) Inventor: Albert G. Langella, Hartsdale, NY (US)

(21) Appl. No.: 13/227,374

(22) Filed: Sep. 7, 2011

(51) Int. Cl. H02J 7/00

(52) U.S. Cl. 320/107

(57) ABSTRACT

The invention is a portable electronic computer charging and mounting device that holds and allows for the continual charging of a portable electronic device, such as a smart phone, tablet computer, and/or laptop computer. The mounting and charging device is connected or mounted directly to an electrical junction box.

### FIELD OF THE INVENTION

The invention relates to a device, method, and system for mounting an electronic device to an electrical junction box. More particularly, the invention is a device that holds, and allows for the continual charging of, a portable electronic device (such as a smart phone, tablet computer, and/or laptop computer) to an electrical junction box.

### BACKGROUND OF THE INVENTION

People who need to take their electronic files and computers with them as they travel have used portable computers for decades. The portable computer now includes a wide range of products, including smart phones, personal digital assistants, portable gaming systems, portable media players, portable DVD players, laptop computers, and tablet computers. As these electronic devices and computers have gotten smaller, they have incorporated the use of touch screen technology to reduce or even eliminate the need for keyboards, mouses, and other data entry devices, to be constantly connected to the device. The widespread incorporation of soft-key touch screen keypads have made the portable electronic device a versatile computing device that is able to run numerous types of applications or programs without having to tether the device to a keyboard or physical keypad.

In addition to incorporating the soft-key technology into general use electronic devices, such as the consumer smart phones and tablet computers, touch screen technology has also been incorporated into dedicated specific function soft-key controllers, such as thermostats and multimedia system controllers. Rather than use an off-the-shelf consumer smart phone or tablet computer as a soft-key controller for various controlling and media storage functions, hardware providers are exclusively creating dedicated specific function soft-key touch screen controllers. Depending on what the dedicated specific function soft-key touch screen controllers are designed to do, these devices may be portable, as with shipping and receiving scanners, or they may be mounted to a wall, as with thermostats.

Regarding references that disclose the use of an off-the-shelf consumer smart phone or tablet computer being used as a controller, rather than a dedicated hard-key or soft-key controlling unit, U.S. Published Patent Application No. 2009/0174998, filed by Struthers et al., discloses such a controller. Struthers specifically discloses and claims a smart phone or tablet computer being used to control and/or provide media files to an existing home entertainment system that is already wired into a home Importantly, the Struthers Patent Application is directed specifically to a wall mount for the smart phone or tablet computer and the mount is specifically designed to allow the electronic computing device to be easily attached and removed from the mount. Because the Struthers device is mounted to a wall, the installation of the device requires significant construction, and which results in the permanent defacement of that part of the wall in which the Struthers device is mounted. Struthers fails to disclose a device that is mounted to an electrical junction box.

Thus, what is needed is a portable electronic device mounting and charging device that is not mounted to a wall and is instead mounted to an existing electrical junction box.

### SUMMARY OF THE INVENTION

To minimize the limitations in the prior art, and to minimize other limitations that will become apparent upon reading and understanding the present specification, the present invention discloses a new and useful device, method, and system for charging and mounting a portable electronic computer to an electrical junction box.

One embodiment of the invention is a portable electronic computer charging and mounting device comprising: a base plate; a cover plate; a charging circuit; and an electronic device connector. The base plate is mounted on an electrical junction box. A portable electronic computing device is connected to the electronic device connector and wherein the portable electronic computing device is mounted to a front of the base plate. Preferably, the cover plate is connected to the base plate after the portable electronic computing device is mounted to the front of the base plate and after the portable electronic computing device is connected to the electronic device connector. Preferably, the charging circuit charges the portable electronic computing device. Preferably, the base plate has one or more clamps that hold the portable electronic computing device that is mounted to the base plate. Preferably, the one or more clamps are adjustable. The portable electronic device is preferably able to be continuously charged when connected to the electronic device connector. When the cover plate is connected to the base plate, the portable electronic computing device is preferably viewable, but not removable. The cover plate may be permanently connected to the base plate such that the portable electronic computing device is permanently encased between the cover plate and the base plate. Preferably, the portable electronic device is selected from the group consisting of: cellular telephones; personal digital assistants; smart phones; tablet computers; and laptop computers. The charging circuit may be mounted on a power wire of said electric junction box or on the rear of the base plate, and the charging circuit provides power to said electronic device connector.

It is an object of the present invention to overcome the limitations of the prior art.

It is an object of the present invention to provide a device for mounting a portable electronic device to an electrical junction box. Electrical junction boxes are typically mounted to studs, framing materials, desks, counter tops, cabinets, standpipes, baseboards, and other non-wall portions of a building. In this manner an electrical device can be easily and inexpensively mounted in a myriad of areas in a home or office.

It is an object of the present invention to provide an inexpensive, high-quality mounting and charging station for a smart phone, tablet computer and/or laptop computer.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a perspective view of one embodiment of the portable electronic computer charging and mounting device and shows the base plate.

FIG. 2 is an illustration of a perspective view of one embodiment of the portable electronic computer charging and mounting device and shows a portable electronic computing device attached to the base plate.

FIG. 3 is an illustration of a perspective view of one embodiment of the portable electronic computer charging and mounting device and shows the cover plate.

FIG. 4 is an illustration of a back view of one embodiment of the portable electronic computer charging and mounting device.

FIG. 5 an is illustration of a perspective view of one embodiment of the portable electronic computer charging and mounting device and shows the device attached to a two gang electrical junction box.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

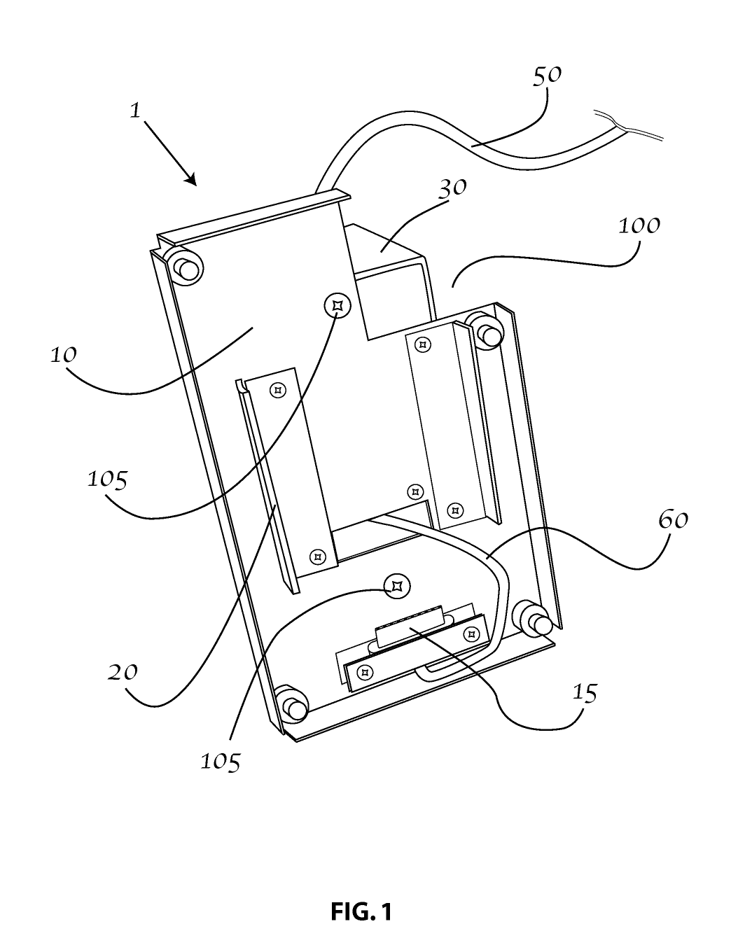

FIG. 1 is an illustration of a perspective view of one embodiment of the portable electronic computer charging and mounting device and shows the base plate. As shown in FIG. 1, the portable electronic computer charging and mounting device 1 preferably includes base plate 10, electrical device connector 15, and clamps 20. The base plate 10 is connected to an electrical junction box 30. Although electrical junction box 30 is shown as a single gang junction box, it should be understood that the electrical junction box may be of any size, including, but not limited to, single, double, or triple gang. Because the base plate 10 is connected to junction box 30, there are electrical wires that are available to power the present invention. FIG. 1 shows how electrical wire 50 preferably provides power to electrical device connector 15 through power wire 60. FIG. 1 also shows how base plate 10 preferably has a notch 100 taken out to reduce the interference with wireless signals that are sent to and from the portable electrical computing device that is installed within the base plate 10.

FIG. 1 shows how the base plate 10 is preferably attached to junction box 30 using screws 105. It should be understood that the base plate 10 may be attached to the junction box 30 using any connector, including, but not limited to: nails, screws, friction, straps, zip-ties, chains, clips, binders, bungees, cords, ropes, strings, cables, fasteners, staples, hook and loop, bands, latches, stitches, snaps, wenches, glue, other natural or synthetic chemical adhesives, adhesive tape, heat bonding, chemical bonding, crimps, clamps, magnets, or ultrasonic welding. Preferably, prior to mounting the base plate 10 to the junction box 30, the base plate may be adjusted so as to be positioned appropriately before the final tightening of the screws 105.

FIG. 1 also shows how clamps 20 are adjustable in order to fit portable electronic computing devices of various sizes.

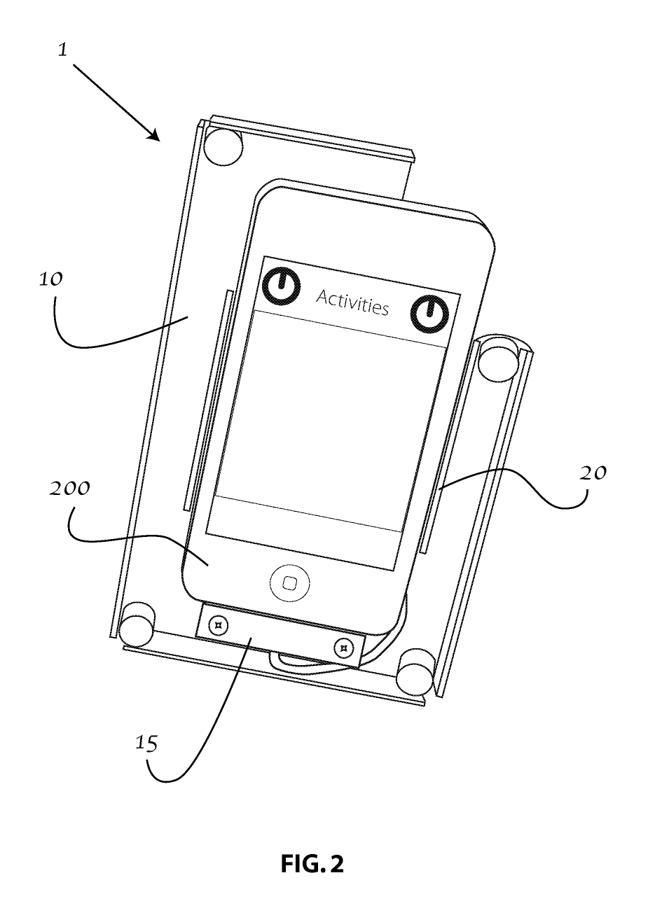

FIG. 2 is an illustration of a perspective view of one embodiment of the portable electronic computer charging and mounting device and shows a portable electronic computing device attached to the base plate. As shown in FIG. 2, the portable electronic computer charging and mounting device 1 preferably includes base plate 10, electronic device connector 15, and clamps 20. The clamps 20 and electronic device connector 15, as shown, preferably securely hold portable electronic computing device 200. Although portable electronic computing device 200 is shown as a smart phone with a touch screen, it should be understood that portable electronic computing device 200 may be a tablet computer, a laptop computer, or any type of portable electronic computing or entertainment device. FIG. 2 shows that when portable electronic computing device 200 is connected to electronic device connector 15, continual charging is available.

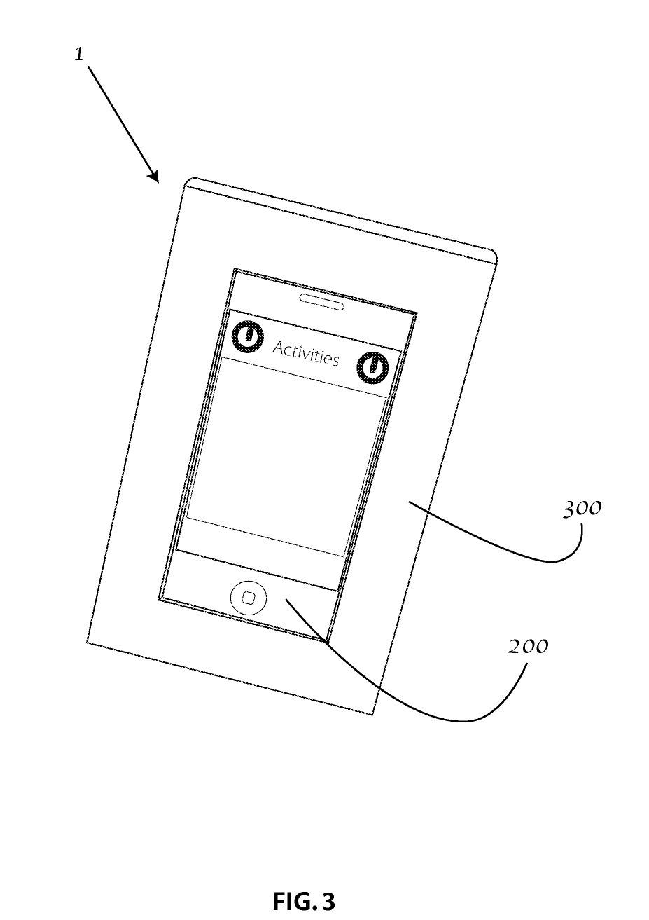

FIG. 3 is an illustration of a perspective view of one embodiment of the portable electronic computer charging and mounting device and shows the cover plate. As shown in FIG. 3, the portable electronic computer charging and mounting device 1 preferably includes cover plate 200, which attaches to base plate 10. FIG. 1 also shows how cover plate 300 encases the mounted portable electronic computing device 200, such that the portable electronic computing device 200 is held securely in place. The cover plate 300 may be attached to the base plate 10 permanently or removeably. FIG. 2 shows how the cover plate 300 is connected to the base plate 10 such that the screen of the portable electronic computing device 200 is viewable, but the device 200 itself is not removable.

The cover plate 300 may be attached to the base plate 10 through any connector, including, but not limited to: nails, screws, friction, straps, zip-ties, chains, clips, binders, bungees, cords, ropes, strings, cables, fasteners, staples, hook and loop, bands, latches, stitches, snaps, wenches, glue, other natural or synthetic chemical adhesives, adhesive tape, heat bonding, chemical bonding, crimps, clamps, magnets, or ultrasonic welding.

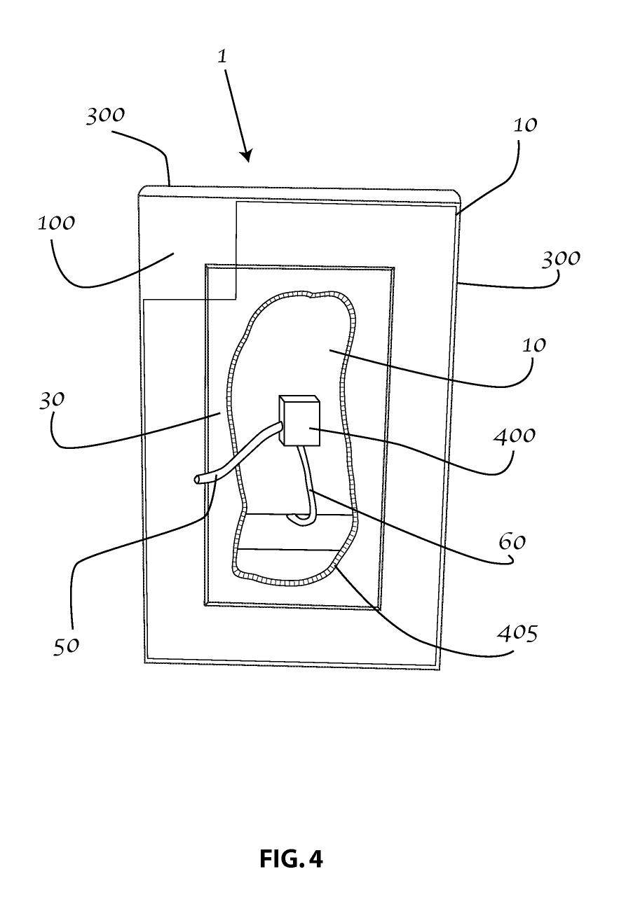

FIG. 4 is an illustration of a back view of one embodiment of the portable electronic computer charging and mounting device. As shown in FIG. 4, the portable electronic computer charging and mounting device 1 preferably includes a base plate 10, a face plate 300, a charging circuit 400, notch 100, electrical wire 50, power wire 60, and electrical junction box 30. The interior of electrical junction box 30 is visible through cut-away 405. Charging circuit 400 preferably takes power from electrical wire 50 and provides power to electrical device connector 15 through power wire 60 in order to charge the connected portable electronic computing device 200. As shown in FIG. 4, the charging circuit 400 may be connected to the rear of base plate 10.

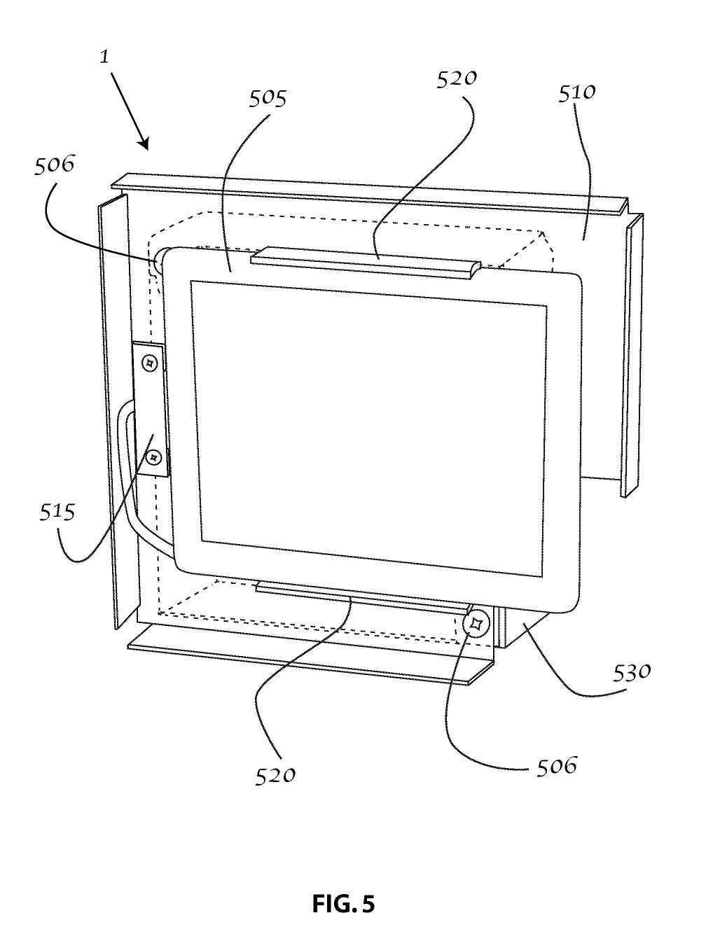

FIG. 5 is illustration of a perspective view of one embodiment of the portable electronic computer charging and mounting device and shows the device attached to a two gang electrical junction box. As shown in FIG. 5, portable electronic computer charging and mounting device 1 may be connected to a two gang electrical junction box 530. FIG. 5 shows that portable electronic computer charging and mounting device 1 is holding a tablet computer 505 in a landscape position through clamps 520 and electrical device connector 515. FIG. 5 shows that the base plate 510 is connected to electrical junction box 530 through screws 506.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A portable electronic computer charging and mounting device comprising:
a base plate;
a charging circuit; and
an electronic device connector;
wherein said base plate is mounted on an electrical junction box;
wherein a portable electronic computing device is connected to said electronic device connector and wherein said portable electronic computing device is mounted to a front of said base plate; and
wherein said charging circuit charges said portable electronic computing device.

2. The portable electronic computer charging and mounting device of claim 1, further comprising:
a cover plate;
wherein said cover plate is connected to said base plate after said portable electronic computing device is mounted to said front of said base plate and after said portable electronic computing device is connected to said electronic device connector.

3. The portable electronic computer charging and mounting device of claim 2, wherein said charging circuit is connected to a rear of said base plate; and wherein said charging circuit provides a power to said electronic device connector.

4. The portable electronic computer charging and mounting device of claim 3, wherein said base plate has one or more clamps that hold said portable electronic computing device that is mounted to said base plate.

5. The portable electronic computer charging and mounting device of claim 4, wherein said one or more clamps are adjustable.

6. The portable electronic computer charging and mounting device of claim 5, wherein when said portable electronic device is connected to said electronic device connector, continual charging is available.

7. The portable electronic computer charging and mounting device of claim 6, wherein when said cover plate is connected to said base plate, said portable electronic computing device is viewable, but not removable.

8. The portable electronic computer charging and mounting device of claim 7, wherein said cover plate is permanently connected to said base plate such that said portable electronic computing device is permanently encased between said cover plate and said base plate.

9. The portable electronic computer charging and mounting device of claim 8, wherein said portable electronic device has a touch screen.

10. The portable electronic computer charging and mounting device of claim 9, wherein said portable electronic device is selected from the group consisting of: cellular telephones; personal digital assistants; smart phones; tablet computers; and laptop computers.

11. The portable electronic computer charging and mounting device of claim 1, wherein said base plate has one or more clamps that hold said portable electronic computing device that is mounted to said base plate.

12. The portable electronic computer charging and mounting device of claim 11, wherein said one or more clamps are adjustable.

13. The portable electronic computer charging and mounting device of claim 1, wherein said portable electronic device is selected from the group consisting of: cellular telephones; personal digital assistants; smart phones; tablet computers; and laptop computers.

14. The portable electronic computer charging and mounting device of claim 1, wherein when said portable electronic device is connected to said electronic device connector, continual charging is available.

15. The portable electronic computer charging and mounting device of claim 2, wherein when said cover plate is connected to said base plate, said portable electronic computing device is viewable, but not removable.

16. The portable electronic computer charging and mounting device of claim 2, wherein said cover plate is permanently connected to said base plate such that said portable electronic computing device is permanently encased between said cover plate and said base plate.

17. The portable electronic computer charging and mounting device of claim 2, wherein said cover plate is removably connected to said base plate.

18. A portable electronic computer charging and mounting device comprising:
a base plate;
a cover plate;
a charging circuit; and
an electronic device connector;
wherein said base plate is mounted on an electrical junction box;
wherein a portable electronic computing device is connected to said electronic device connector and wherein said portable electronic computing device is mounted to a front of said base plate;
wherein said cover plate is connected to said base plate after said portable electronic computing device is mounted to said front of said base plate and after said portable electronic computing device is connected to said electronic device connector;
wherein said charging circuit charges said portable electronic computing device;
wherein said base plate has one or more clamps that hold said portable electronic computing device that is mounted to said base plate;
wherein said one or more clamps are adjustable;
wherein when said portable electronic device is connected to said electronic device connector, continual charging is available;
wherein when said cover plate is connected to said base plate, said portable electronic computing device is viewable, but not removable;
wherein said cover plate is permanently connected to said base plate such that said portable electronic computing device is permanently encased between said cover plate and said base plate; and
wherein said portable electronic device is selected from the group consisting of: cellular telephones; personal digital assistants; smart phones; tablet computers; and laptop computers.

19. The portable electronic computer charging and mounting device of claim 17, wherein said charging circuit is mounted on a power wire of said electric junction box and wherein said charging circuit provides a power to said electronic device connector.

20. The portable electronic computer charging and mounting device of claim 17, wherein said charging circuit is connected to a rear of said base plate and wherein said charging circuit provides power to said electronic device connector.
